(19) United States
(12) Patent Application Publication
(10) Pub. No.: US 2016/0193573 A1
(43) Pub. Date: Jul. 7, 2016

(54) METHOD AND SYSTEM FOR ENHANCING MASS TRANSFER IN AERATION/OXYGENATION SYSTEMS

(71) Applicant: MALCOLM FABIYI, CHICAGO, IL (US)

(72) Inventor: MALCOLM FABIYI, CHICAGO, IL (US)

(21) Appl. No.: 15/067,973

(22) Filed: Mar. 11, 2016

Related U.S. Application Data
(63) Continuation of application No. 14/576,276, filed on Dec. 19, 2014.
Application No. 14/576,276 is a continuation of application No. 13/687,058, filed on Nov. 28, 2012, now abandoned.
(60) Provisional application No. 61/565,860, filed on Dec. 1, 2011.

(51) Int. Cl. B01F 3/04; B01F 7/22; C02F 1/72; B01F 7/00

(52) U.S. Cl. CPC B01F 3/04262; B01F 3/04248; B01F 7/00733; B01F 7/22; C02F 1/727; B01F 2003/04319; C02F 2101/301

(57) ABSTRACT

A means for obtaining high mass transfer efficiencies in surfactant laden wastewater treatment or process systems is disclosed. The present system employs ultrafine bubbles delivered into a high shear region such as in the draft tube or other containment volume of a mechanically agitated contacting system within which an impeller is placed, or in the venturi or divergent-convergent of a pumped loop within which gas-liquid contacting is carried out.

### CROSS REFERENCE TO RELATED APPLICATIONS

This application is continuation of U.S. patent application Ser. No. 14/576,276, filed Dec. 19, 2014, which is a continuation of U.S. patent application Ser. No. 13/687,058, filed Nov. 28, 2012, and claims the benefit of and priority to U.S. Provisional Patent Application Ser. No. 61/565,860, filed on Dec. 1, 2011, the disclosure of which is incorporated by reference herein.

### FIELD OF THE INVENTION

This invention relates to a method and system for enhancing mass transfer in aeration and oxygenation systems. More particularly, this invention relates to a method and system for improving the oxygen transfer efficiency in aeration and oxygenation systems used in wastewater treatment plants.

### BACKGROUND

In wastewater treatment processes or other processes where gas liquid contacting is required, the presence of surfactants in the process fluids can modify the mass transfer capabilities of gas-liquid contacting devices, severely decreasing the effectiveness of mass transfer in such systems. The resulting effect can be a decrease in production yields, a reduction in reaction rates, lower utilization of process materials such as gases and process liquids, as well as the need for larger process tanks and/or reactors to compensate for low process kinetic rates.

In wastewater treatment systems in particular, the wastewater to be treated can include surfactant products. The presence of such surfactants can significantly impair the ability to transfer oxygen into the water. Some surfactants are known to induce a “rigid” bubble effect, which significantly alters the ability of a superimposed shear and turbulence field to induce either bubble coalescence or bubble breakup. Also, because surfactants accumulate at the bubble-liquid interface, they affect surface tension, impede gas diffusion into the liquid and hinder interfacial renewal.

There are three broad classes of gas-liquid contacting devices, including: (i) mechanically agitated contactors; (ii) diffuser and sparger systems; and (iii) side stream pumping systems. Mechanically agitated contactors generally possess one of more moving parts that provide agitation, and might also include the capacity for gas induction or aspiration. Diffuser and sparger systems generally require the introduction of gaseous bubbles into a process tank, with the bubbles providing agitation with the size of the bubbles being utilized as a means for enhancing mass transfer and/or mixing. The bubble sizes are controlled using the pore sizes on the spargers or diffusers or leveraging venturi or converging-diverging nozzles and velocity aided entrainment effects to facilitate mixing and bubble dispersion. Lastly, the side stream pumping systems can be used to dissolve high concentrations of the solute gas into a side stream that is then mixed back in with the bulk process flow. The presence of surfactants in process streams, in which any of these devices are applied using conventional approaches, is known to impair the capacity for mass transfer and for efficient gas-liquid contacting.

### SUMMARY OF THE INVENTION

The present invention may be characterized as a wastewater treatment system for treating surfactant laden wastewater comprising: (i) an aeration basin; (ii) a source of oxygen; (iii) a mechanical agitating contactor disposed in the aeration basin, the mechanical agitating contactor comprising a draft tube having at least one inlet opening and at least one discharge opening and with an agitator or impeller disposed therein to create a flow of the surfactant laden wastewater by drawing the wastewater into the draft tube from the at least one inlet opening and discharging the liquid flow from the at least one discharge opening; and (iv) an oxygen injection system disposed below the surface of the surfactant laden wastewater and proximate to the mechanical agitating contactor and operatively coupled to the source of oxygen, the oxygen injection system adapted to produce oxygen bubbles proximate the impeller, the oxygen bubbles having an average diameter of less than or equal to 100 microns.

Preferably, the impeller is a downward pumping helical impeller operatively coupled to a motor configured to rotate the impeller at a sufficient speed such that the surfactant laden wastewater drawn into the draft tube has a minimum superficial velocity greater than a terminal ascent velocity of the oxygen bubbles to enable the entrainment of the oxygen bubbles into the surfactant laden wastewater discharged from the draft tube.

The oxygen injection system is arranged or configured as one or more spargers located inside the draft tube and having a plurality of openings formed by a metallic, sintered metal or polymeric ultrafine bubble surface layer. In one embodiment, the spargers are ring-like elements located inside the draft tube and having an inlet for the oxygen penetrating a sidewall of the draft tube. An alternative arrangement or configuration of the oxygen injection system includes a plurality of nozzles situated above or below or alongside the agitator or impeller.

Alternatively, the present invention may be characterized as a wastewater treatment system for treating surfactant laden wastewater in a sidestream pumping system that includes: (i) a sidestream loop fluidically coupled to a basin in a wastewater treatment facility; (ii) a mechanical agitating contactor disposed in the sidestream loop, the mechanical agitating contactor comprising an agitator or impeller configured to create a flow of the surfactant laden wastewater in the sidestream loop; (iii) a source of oxygen; and (iv) an oxygen injection system disposed below the surface of the surfactant laden wastewater and proximate to the mechanical agitating contactor and operatively coupled to the source of oxygen, the oxygen injection system adapted to produce oxygen bubbles proximate the agitator or impeller, the oxygen bubbles having an average diameter of less than or equal to 100 microns.

The present invention may also be characterized as a method of treating surfactant laden wastewater in a basin or vessel, the basin or vessel having a mechanical agitating contactor submerged therein. The mechanical agitating contactor comprises a draft tube having at least one inlet opening and at least one discharge opening and an agitator or impeller disposed within the draft tube. The method comprises the steps of: (i) rotating the agitator or impeller disposed within the draft tube to create a flow of the surfactant laden wastewater by drawing the wastewater into the draft tube from the at least one inlet opening and discharging the wastewater from the at least one discharge opening; and (ii) injecting oxygen bubbles into the surfactant laden wastewater within the draft tube at a location proximate the agitator or impeller, wherein the surfactant laden wastewater drawn into the draft tube has a minimum superficial velocity greater than a terminal ascent velocity of the oxygen bubbles to enable the entrainment of the oxygen bubbles into the surfactant laden wastewater discharged from the draft tube. In addition, the oxygen bubbles entrained in the surfactant laden wastewater discharged from the draft tube have an average bubble diameter of less than or equal to 100 microns.

### BRIEF DESCRIPTION OF THE DRAWINGS

The above and other aspects, features, and advantages of the present invention will be more apparent from the following, more detailed descriptions thereof, presented in conjunction with the following drawings, wherein:

FIG. 1 is a graph that depicts the treatment achieved and oxygen transfer efficiencies in a surfactant laden wastewater treatment plant using conventional aeration or oxygenation systems over a seven month span;

FIG. 2 is an illustration of a mechanically agitating contactor in accordance with an embodiment of the invention;

FIG. 3 is an illustration of an alternative mechanically agitating contactor arrangement in accordance with another embodiment of the invention;

FIG. 4 is a fragmentary schematic, sectional view of the apparatus shown in FIG. 3;

FIG. 5 is a chart that depicts test results comparing the mass transfer efficiency realized when using the present invention with conventional aeration methods in clean water samples as well as three different high surfactant laden water samples; and

FIG. 6 is another chart that depicts test results showing the alpha factor realized when using the present invention with conventional aeration methods in the clean water samples as well as three different high surfactant laden water samples.

### DETAILED DESCRIPTION

The present system and method provides a means for obtaining high mass transfer efficiencies in surfactant laden wastewater treatment systems or other process systems by utilizing ultrafine bubbles delivered into a high shear region such as in the draft tube or other containment volume of a mechanically agitated contacting system within which an impeller is placed, or in the venturi or divergent-convergent of a pumped loop within which gas-liquid contacting is carried out.

By leveraging known features of surfactants, such as their ability to ‘rigidify’ bubbles and to disable the tendency for bubble coalescence, the high surface areas provided by the ultrafine bubbles can be retained. The high shear regime imposed allows the impairment to mass transfer induced by the reduction of surface renewal rates to be overcome, thereby enabling high mass transfer efficiencies to be obtained.

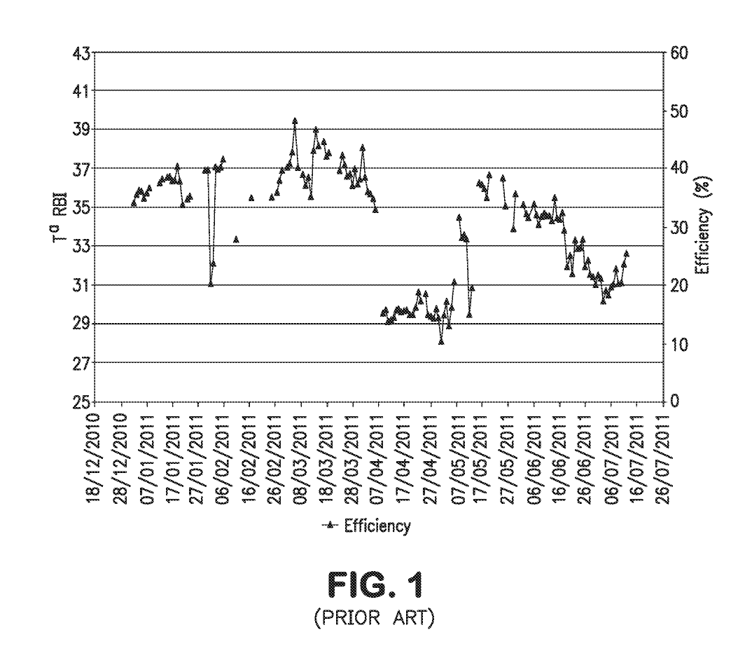

Turning now to FIG. 1, there is shown a graph that depicts the treatment achieved and oxygen transfer efficiencies in a surfactant laden wastewater treatment plant using conventional aeration. The wastewater plant is an external MBR based process that treats wastewater from a polyethylene (PET) manufacturing plant. The influent is high strength, with a COD of about 20,000 mg/L and flow of 240 m3/d. Conventional aeration is supplied with pure oxygen aeration, primarily with two Praxair in-situ oxygenator (I-SO™) systems. The measured oxygen transfer rate (OTR), based on continuous monitoring, is substantially below the design value. The basis for the low OTR was found to be a low alpha factor, estimated at between about 0.35-0.40. Expected values of the alpha factor for the same I-SO™ system with similar MLSS conditions but at another facility with different wastewater content were significantly higher and estimated to be between about 0.7-1.0.

Two key characteristics of the mixed liquor were investigated in the laboratory to determine their impact on the alpha factor for oxygen dissolution. The two key characteristics are the high viscosity linked to high MLSS levels (11-12 g/L) and amount of surfactants such as ethylene glycol in the influent wastewater. Both of these constituents were found to have a substantial detrimental impact on alpha factor, which was depressed to between about 0.3-0.4 when both constituents were present. Modifications to the oxygen injector type and location (i.e. from headspace injection of gas to ultrafine-bubble sparger below the surface, in an area of high shear) were found to improve alpha factor substantially, such that alpha factor could be restored close to a value of 1.0, even in the presence of high viscosity and high concentrations of ethylene glycol. As a result of the laboratory tests, the injector type on the I-SO™ oxygenation system was modified and changed to an ultrafine-bubble sparger located near a high-shear region of the submerged mechanical agitating contactor. Beneficial impacts to the OTR and alpha factor were realized with these equipment modifications. In general, aeration equipment is optimized for performance in clean water conditions. However, as these tests demonstrate, optimization for field conditions should also be considered in order to minimize operating costs and equipment capital requirements. The tests suggest that parameters such as alpha factor, which are typically viewed as being defined for a particular mixing and wastewater system, can be optimized by incorporating fundamental mass transfer concepts into the evaluation of oxygen transfer efficiency in actual field systems.

The presently disclosed system and method utilize ultrafine pore sizes spargers to introduce ultrafine bubbles having an average bubble diameter of less than or equal to about 100 microns directly into the pumped liquid flow of mechanically agitated contacting systems. The mechanically agitating contactor may be part of a submerged aeration device/mixer or a near surface aeration device/mixer. Alternatively, the mechanically agitated contacting system may be disposed in a sidestream loop or sidestream pumped configuration. In the case of sidestream systems, an ultrafine sparger usually made from sintered metal or a polymeric material with ultrafine pores equal to or less than about 100 microns is used for gas delivery and is incorporated into the venturi or convergent-divergent nozzle, or other gas delivery approach utilized in such sidestream systems.

It is also well known that the use of fine or ultrafine bubbles by themselves is not sufficient to observe the effect of improved mass transfer in surfactant laden systems. The superimposition of a high shear system of a mechanically agitating contacting system on the fine or ultrafine bubbles is essential, but not sufficient for ensuring that efficient mass transfer is obtained. For example, in systems that possess high shear component using a combination of mechanically agitated contactors and pumping loop gas-liquid contacting, oxygen transfer efficiencies in the region of <40% have been observed. The importance of the initial bubble size for affecting the mass transfer in surfactant laden systems in high shear regimes has not been addressed or properly understood in the prior art.

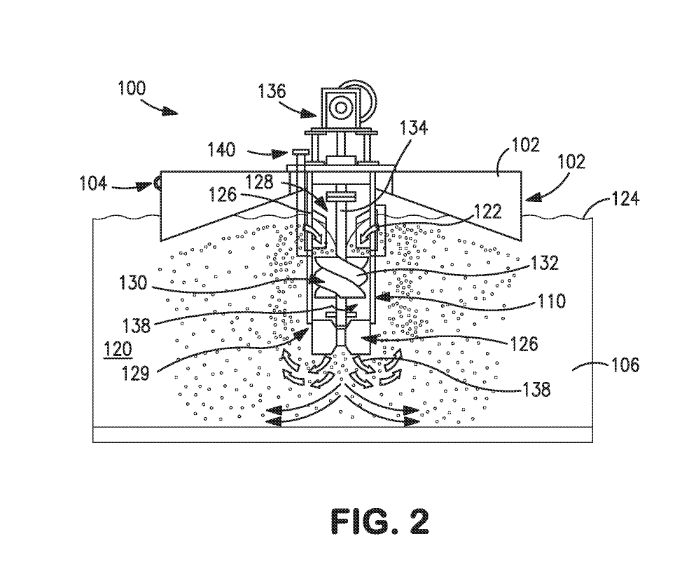

Turning now to FIG. 2, there is shown an embodiment of the aeration system used with the present system and method of enhancing oxygen mass transfer in an aeration basin of a wastewater treatment system 100. As seen therein, the aeration system is a near surface aeration system and includes a float assembly 102 having an anchor ring 104 which is placed in an aeration basin 106 of a wastewater treatment system 100. In the present application, the liquid within the aeration basin 106 is a surfactant laden wastewater 120, typically with an MLSS of between about 4-20 grams/L with the influent COD between about 10,000 to 20,000 mg/L.

Extending in a downward orientation from the float assembly 102 is a draft tube 110. The draft tube 110 preferably has circumferential openings 122 located below the top surface 124 of the surfactant laden wastewater 120 in the aeration basin 106. Baffles 126 are equilaterally spaced and symmetrically positioned around the openings 122 which are proximate to the entrance 128 to the draft tube 110. Additional baffles 126 can be located proximate the exit 129 of the draft tube 110. A helical impeller 130 is disposed within the draft tube 100 and generally comprises one or more blades 132 that are affixed to the impeller shaft 134 for rotation with the impeller shaft 134 by motor 136, which is preferably placed on top of the float assembly 102.

The motor 136 is adapted to drive the impeller shaft 134, and in turn move the liquid and gas within the draft tube 110 in a downward direction. The exiting gas-liquid jet is then dispersed in the direction of arrow 138. The oxygen gas is preferably introduced through the gas inlet 140 which discharges the oxygen gas via a sintered metal disk, ceramic membrane or polymeric ultrafine pore diffuser ring disposed below the top surface 124 of the liquid and above impeller 130 and preferably proximate the openings 122 or distal end of the baffles 126. The sintered metal disk, ceramic membrane, or polymeric ultrafine pore diffuser ring have a pore size of less than or equal to about 100 microns so as to deliver very fine bubbles of high purity oxygen directly into the surfactant laden wastewater. By introducing the high purity oxygen below the water level, it is guaranteed that the gas is indeed delivered as fine bubbles into the liquid matrix. Recirculation of the surfactant laden wastewater 120 occurs as a result of a mechanical agitation within the draft tube 110 and the corresponding downward force of the high solids content liquid 120 in the draft tube 110. As the surfactant laden wastewater with gas bubbles is ejected from the exit 129 of the draft tube 110, a suitable volume of replacement liquid 120 having some mass of gas is ingested through openings 122 near the entrance 128 of draft tube 110.

Alternatively, the sintered metal disk, ceramic membrane or polymeric ultrafine pore diffuser ring may be disposed below the impeller 130, but within the draft tube enclosure 110. The source of oxygen delivered to the gas inlet port 140 can be either from a high-purity liquid or gas source at the wastewater plant or can be the oxygen containing vent gas from a secondary or tertiary ozonation system.

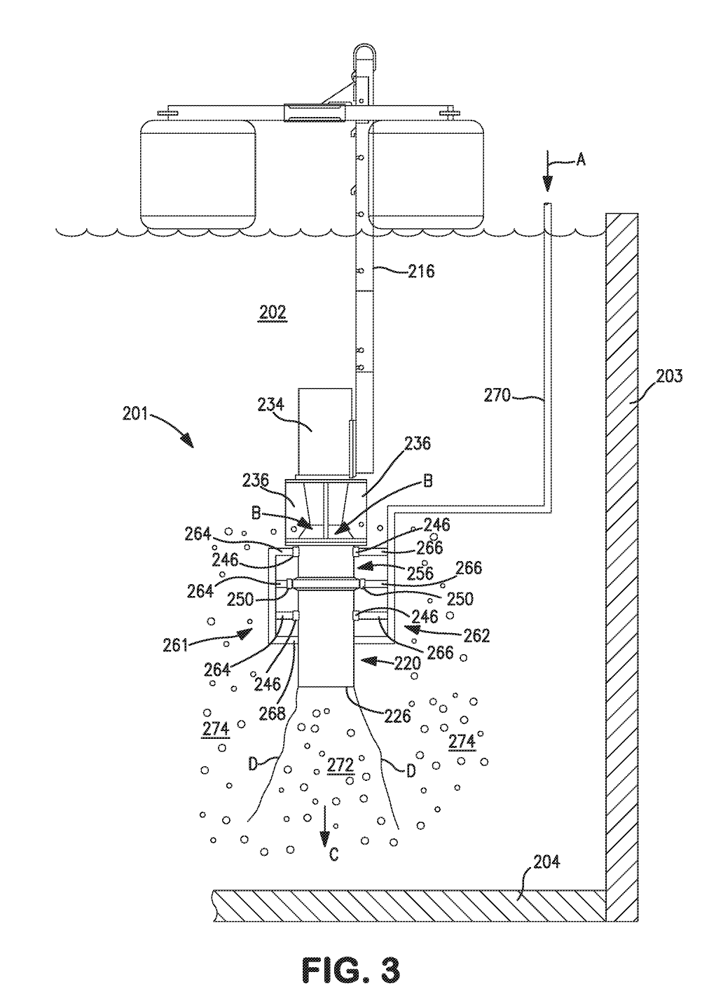

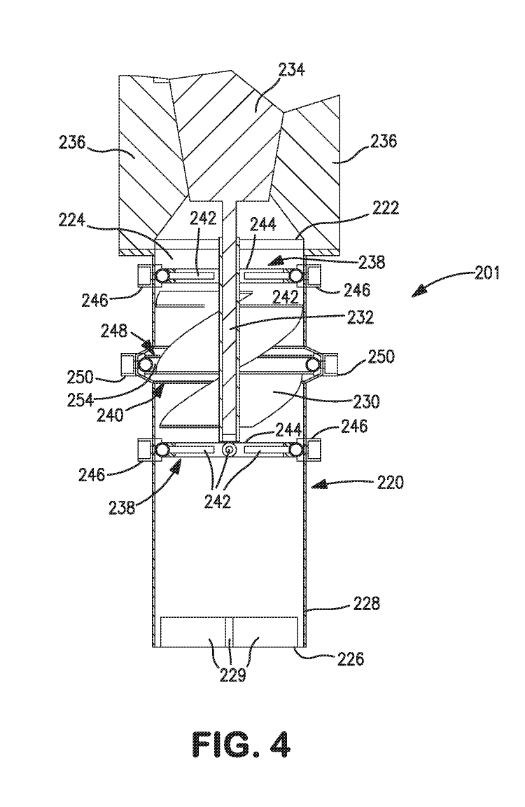

An alternate embodiment of the present system and method contemplates use of a submerged aeration system as the mechanically agitating contactor system. With reference to FIG. 3 and FIG. 4, an apparatus 201 in accordance with the present invention is illustrated. Apparatus 201 is designed to inject oxygen indicated by arrowhead “A”, into a surfactant laden wastewater 202 which for purposes of illustration is shown as contained in a tank having sidewalls 203. Apparatus 201 is provided with a draft tube 220 that has an inlet opening 222 formed by an open end 224 of the draft tube 220. It is understood that inlet openings could also be situated at the sidewall of the draft tube with the corresponding end of the draft tube closed. A discharge opening 226 is located at the opposite end 228 thereof. A helical impeller 230 is located within the draft tube 220 that is driven by a shaft 232 attached to a motor 234. Motor 234 is connected to the draft tube 220 by means of blade-like elements 236. Motor 234 is also connected to the downwardly extending member 216 to thereby connect apparatus 201 to downwardly extending member 216. Motor 234 can be an electric motor of the type that is capable of functioning while submerged in the liquid. Gas driven motors are also possible. However, embodiments of the apparatus 201 are possible in which operations are conducted close to the surface of the liquid 202; and in such case, the motor 234 might not be of the type that is capable of submerged operations.

Helical impeller 230 is preferably designed so that at each revolution, a volume of liquid is propelled through the draft tube 220 having a volume that approaches the volume of liquid proximate to, and situated below the helical impeller 230 in the draft tube. Additionally, there must be some minimal clearance between the helical impeller 230 and the sidewall forming the draft tube 220. This clearance is designed to be at least less than or equal to 30% of the impeller diameter, and preferably about 10% of the impeller diameter or less.

As can best be seen in FIG. 3, opposed manifolds 261 and 262 are provided having feed conduits 264 and 266, respectively, which are in turn connected to the opposed inlets 246 and 250 of the oxygen injectors 238. Manifold 261 is connected to manifold 262 by means of a connecting conduit 268 and manifold 262 is in turn connected to a supply pipe 270 through which the oxygen gas “A” is fed from a compressed gas source. Rotation of the helical impeller 230 creates a liquid flow by drawing the surfactant laden wastewater 202 into the draft tube 220 from the inlet opening 222 as indicated by arrowheads “B”. The liquid flow is then discharged from the discharge opening 226 as indicated by arrowhead “C”. As shown in FIG. 4, preferably, a cruciform flow arrangement of guide vanes 229 can be provided at the discharge opening 226 as a flow straightener to promote flow in the direction of arrowhead “C” by helping to remove rotation within such flow as well as to impart further shear to the wastewater being discharged.

Situated within the draft tube 220 are a plurality of gas injectors that are designed to inject gas in the form of bubbles into the surfactant laden wastewater flow passing through the draft tube 220. In the illustrated embodiment, two gas injectors 238 are situated above and below the impeller 230 and a gas injector 240 is located alongside the impeller 230. The gas injectors inject oxygen gas bubbles into the flow within the draft tube 220. When aerating the high surfactant wastewater, it is beneficial to inject more of the oxygen above the high shear helical impeller preferably using sintered metal sparger systems that allow fine bubbles to be contacted with the liquid in the high shear region proximate to and within the helical impeller region. Injecting more of the gases at the point of maximum shear allows for optimal gas-liquid contacting and dispersion of bubbles.

Each of the injectors 238 has a plurality of elongated spargers 242 located inside the draft tube 220 at radially spaced locations which can be, for example at a 90 degree spacing. If a greater number of spargers 242 are provided, then the spacing would be less than 90 degrees. Each of the spargers 242 is preferably formed by a metallic, sintered metal or a polymeric ultrafine bubble surface layer to form a plurality of injector openings from which the oxygen bubbles are injected into the flow within draft tube 220. The spargers 242 are of generally cylindrical configuration and the gas bubbles will emanate principally from the curved side surfaces thereof. The spargers 242 are preferably connected to a ring-like manifold 244 that is also located within the draft tube 220. Opposed inlets 246 feed the ring-like manifold with the gas “A” and therefore, the spargers 242. The opposed inlets 246 are connected to and penetrate the sidewall forming the draft tube 220. Where larger size oxygen bubbles are needed, the spargers can be replaced with a plurality of nozzles, with each nozzle being of cylindrical configuration and is provided with an axial, cylindrical passage 243 terminating in an opening from which the gas bubbles enter the liquid. Such passage can range from 500 microns to 1 millimeter in diameter to form bubbles of between about 500 microns and about 1 millimeter.

A further alternative arrangement for the oxygen injection is to use a ring-like gas injector formed with an outer solid section and an inner porous section connected to the outer solid section. The inner porous section is preferably formed by a metallic, sintered metal or polymeric ultrafine bubble surface layer to provide the plurality of openings from which the gas bubbles emanate into the draft tube. In order to obtain the bubble size of the injected gas bubbles, the spargers 242 of the gas injectors 238 are provided with average pore sizes that are of the desired bubble size given that the injected gas bubbles cannot be smaller than the pores from which the gas is injected into the surfactant laden wastewater 202. The oxygen flow to the gas injectors is important in that if the oxygen flow is too high, the oxygen bubbles will recombine within the draft tube and therefore, not be in the desired size range. In case of metallic, sintered metal or a polymeric ultrafine bubble surface layer, the average pore size and therefore the bubble size can range between about 10 microns and about 500 microns.

During operation of the apparatus 201, a recirculation loop is created for undissolved gas bubbles that are discharged from the discharge opening 226 and to the extent such gas bubbles remain undissolved that are recaptured within the liquid flow “B” being drawn into the inlet opening 222 of the draft tube 220. In such recirculation loop a portion of the gas bubbles dissolve in the liquid flow inside of the draft tube 220 and a remaining portion of the gas bubbles 272 are discharged from the discharge opening 226 and are carried into the liquid 202, within the liquid flow, where part of the remaining portion of the gas bubbles 272 dissolve in the wastewater 202. A further part of the remaining portion of the gas bubbles 274 due to their buoyancy rises within the liquid 202 to be entrained into the liquid “B” drawn into the draft tube 20 through the inlet opening 222. In order to accomplish this, the gas bubbles that are injected must have at least a substantially uniform diameter of between 10 microns and 1 millimeter. A gas bubble diameter within this range serves two purposes. The small bubble size will of course enhance the surface area of the gas bubbles and therefore, a dissolution rate of the gas “A” within the surfactant laden wastewater 202. Additionally, the buoyancy imparted to such small gas bubbles or micro bubbles, due to their size will result in at least a substantially low uniform terminal ascent velocity that can be controlled. This control of ascent velocity will allow a matching of such velocity with a superficial velocity of the liquid “B” being drawn into the inlet opening of the draft tube. The superficial velocity of the liquid “B” is controlled by the rotation speed of the helical impeller 230 that is imparted to the impeller 230 by the motor 234 and the shaft 232 thereof. This entrainment, depending upon the amount of gas injected, can act to substantially prevent escape of the gas from the surface of the wastewater in the basin. In this manner, the small bubble size is controlled to obtain a uniform, terminal ascent velocity less than the superficial velocity of the liquid “B” and allow a substantial portion of the gas to be recaptured for recirculation back into the draft tube 220.

The amount of gas “A” dissolved during the gas-liquid contacting process in the draft tube 220 is determined by several factors that include: (i) the length of the draft tube 220; (ii) the effective pressure in the draft tube 20; (iii) solubility of the gas under the temperature and pressure conditions in the draft tube 220; (iv) the shear and mixing conditions in the draft tube 220; (v) the size of the bubbles, which will determine the interfacial surface area available for gas-liquid contacting; (vi) the ratio of gas to liquid volumes; and (vii) the time available for gas-liquid contact in the draft tube 220. The quantity of un-dissolved gas bubbles 272 that are ejected at the discharge opening 226 of the draft tube 220 are therefore determined by the effectiveness of the mass transfer process in the draft tube 220 as outlined above. In addition, the surface area of the metallic, sintered metal or polymeric ultrafine bubble surface layers will also have a direct influence on the amount of gas that can be dissolved in the surfactant laden wastewater.

The down-pumping action of the impeller 230 in the draft tube 220 sets up the recirculation loop, described above, with a maximum volumetric flow which is determined by the free, or sweep volume in the draft tube 220 and the rotational speed of the impeller 230. The range covered by the recirculation loop i.e., its horizontal reach will be a function of several variables which include: (i) liquid height over the inlet opening 222; (ii) intrinsic liquid suction draw that can be determined by multiplying the swept volume within the draft tube 220 or in other words, the volume of liquid evacuated from the draft tube by the helical impeller 230 during each rotation by the rotational speed of the helical impeller 230; and (iii) the clearance of the draft tube 220 from the bottom of the basin containing the liquid 202 which in the illustration is the basin bottom 204. This clearance can affect the presence or development of secondary mixing currents which can aid or impede the primary circulation flow. The horizontal range of the recirculation loop affects how much un-dissolved gases are recoverable. A wide horizontal range enables a larger quantity of un-dissolved gases to be captured.

The un-dissolved gas bubbles 274 are entrained in the high velocity jet “C” ejected at the discharge opening 226 of the draft tube 220. The bubbles will continue to be carried downwards in this jet as long as the viscous drag of the liquid exceeds the upward buoyancy force of the bubble. The liquid jet transfers momentum to proximate layers of the bulk liquid as it travels downwards. As shown by lines “D”, the velocity of the jet “C” will decrease due to the viscous drag and hence, the jet of the liquid flow emanating from outlet opening 26 will tend to diverge as the velocity decreases. At a certain critical depth, the viscous and buoyancy forces balance out and the bubbles disengage. In general, the terminal ascent velocity of the gas bubbles 272 exceeds the bulk velocity of the entraining liquid jet at this point. Any un-dissolved gases captured in the liquid circulation loop will need to overcome the high velocity of the entrainment stream to break the liquid surface. For instance, assuming average bubble diameters of about 1 millimeter, Stokes law dictates that a spherical gas bubble in water will have a terminal rise velocity of about 0.55 meters/second.

In contrast, the superficial liquid flow velocity of the liquid flow “B” being drawn into the inlet opening 222 of the draft tube is about 6.4 meters/second. In this regard, as used herein, the term “superficial velocity” when used in connection with the liquid flow velocity of the liquid flow “B” means the flow rate through the draft tube 220 divided by the cross-sectional area thereof. The higher value of the ratio between the superficial liquid velocity in the draft tube to the terminal rise velocity of the bubble ensures that undissolved gases are entrained in the liquid circulatory flow and do not break the surface. By ensuring that a higher relative value of superficial liquid velocity in the draft tube to the terminal bubble rise velocity is maintained, reliable capture and recovery of un-dissolved gases can be achieved without a collection hood or containment surface.

In wastewater treatment processes, the impact of viscosity of the solution on the efficacy of the mass transfer process can be tracked using various parametric measures. In particular, the Standard Oxygen Transfer Rate (SOTR) is ascertained by performing standardized aeration tests using clean water under specified test conditions, namely 20° C., zero dissolved oxygen and a pressure of 760 mm Mercury. Mass transfer rates obtained in field test conditions other than the SOTR specific test conditions are referred to as Actual Oxygen Transfer Rate (AOTR).

It is known that as the viscosity of the wastewater increases, either due to an increase in the solids levels in the wastewater or due to an increase in the viscous components of the waste stream, the Actual Oxygen Transfer Rate, or AOTR using conventional wastewater aeration schemes falls to a value that is lower than the empirically determined SOTR. The variation in the AOTR and the SOTR are generally due to differences in the mass transfer coefficient, (K_{L}a) between the standard or controlled process conditions and the actual process conditions. The ratio of the mass transfer coefficient in actual conditions to the mass transfer coefficient in standard conditions is given by a parameter known as the alpha factor (α),

where:

$$α = \frac{{K}_{L} a ( Actual system )}{{K}_{L} a ( Clean water )}$$

The relationship between the mass transfer coefficient, K_{L}a, and the Actual Oxygen Transfer Rate is generally represented by the following equation:

$$A O T R = S O T R ( \frac{β {C}_{\overline{S}} {,}_{T , H} - {C}_{L}}{{C}_{s , 20}} ) ( {1.024}^{T - 20} ) ( α ) ( F )$$

where β is the salinity-surface tension correction factor, F is the fouling factor, and C_{S̅,T,H} is the average dissolved oxygen concentration in clean water in an aeration basin at temperature T (° C.), and altitude H (m). Where all other variables stay constant, the alpha factor provides a measure for the ratio of the AOTR and the SOTR.

### EXAMPLES & TEST SAMPLES

All tests were conducted in 2 liter beakers. The test process required preparation of each test sample with components selected from the group of clean water, carboxyl methylcellulose (CMC), and ethylene glycol (EG) and mixtures thereof.

CMC was added to solution to modify the viscosity and the rheological properties of the liquid system. All viscosity measurements were carried out CMC is known to be a surrogate fluid that adequately captures the rheological properties of activated sludge systems.

The preferred coarse bubble diffuser system was constructed using a stainless steel tube with an outer diameter of about 6.45 mm, and a wall thickness of about 1.75 mm. The preferred fine bubble diffuser system used in the mass transfer tests was a Mott sintered metal sparger system.

The preferred mixer used in the mass transfer tests was the Lightnin LabMaster Mixer, Model L5U1OF with shearing impeller, having a frequency range of about 50-60 Hz; a maximum current rating of about 4 amps; a maximum power rating of 90 watts; and a maximum RPM of 550.

TABLE 1
Sample Tests

| Water | | | | | | |
|---|---|---|---|---|---|---|
| Sample | | | Mixer | | | |
| (Compo- | Beaker | Fine or Coarse | Speed | Oxygen | EG | CMC |
| nents) | Volume | Bubbles | (rpm) | (L/min) | (mg/L) | (cP) |
| Clean | 2 L | Fine Bubbles (FB) | 550 | 0.1 | N/A | N/A |
| Water | | | | | | |
| EG | 2 L | Fine Bubbles (FB) | 550 | 0.1 | 5000 | N/A |
| Clean | 2 L | Coarse Bubbles (CB) | 550 | 0.1 | N/A | N/A |
| Water | | | | | | |
| EG | 2 L | Coarse Bubbles (CB) | 550 | 0.1 | 5000 | N/A |
| CMC | 2 L | Fine Bubbles (FB) | 550 | 0.1 | N/A | 25 |
| CMC | 2 L | Coarse Bubbles (CB) | 550 | 0.1 | N/A | 25 |
| CMC + EG | 2 L | Fine Bubbles (FB) | 550 | 0.1 | 5000 | 25 |
| CMC + EG | 2 L | Coarse Bubbles (CB) | 550 | 0.1 | 5000 | 25 |

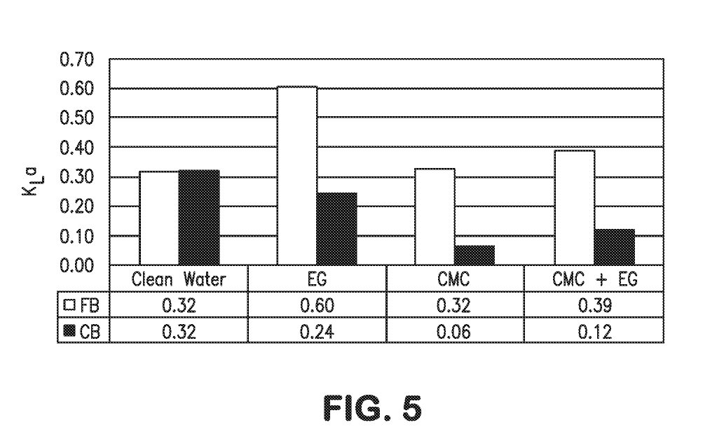

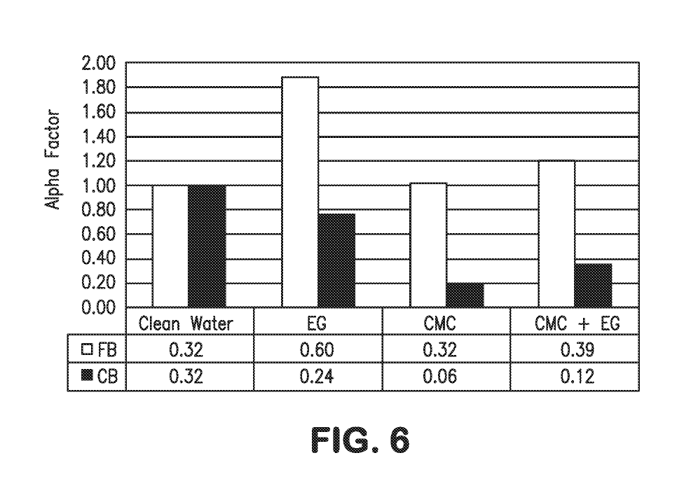

The test results, including the mass transfer efficiencies and alpha factors are shown in FIGS. 5 and 6. As seen therein, a distinct difference in mass transfer characteristics is observed when a surfactant is imposed (e.g., Ethylene Gycol). The fine bubble (FB) system has significantly enhanced mass transfer characteristics, while there is a decrease in the mass transfer (K_{L}a) observed for the coarse bubble (CB) system. Similar changes in mass transfer are observed when gas-liquid contacting is carried out in a highly viscous system such as one that contains Carboxyl Methyl Cellulose, a shear thinning fluid. The results indicate that by carefully altering the dimensions of the bubbles delivered to gas-liquid contacting systems, significant changes in mass transfer can be obtained.

FIGS. 5 and 6 depicts the results from the tests, expressed in terms of mass transfer coefficient (K_{L}a) and alpha factor, respectively. The alpha factor is defined as the ratio of the mass transfer coefficient, K_{L}a, obtained using a specific means for gas-liquid contacting in an ideal system, such as in clean water, relative to the mass transfer coefficient observed with the same mass transfer device under actual process conditions. In this case, the “field” system is considered to be the system with CMC. As seen in FIGS. 5 and 6 as well as in Table 1, the presence of surfactants in the wastewater and viscosity characteristics of the wastewater induce significant changes in mass transfer coefficient (K_{L}a) and alpha factor.

The technical advantages associated with the present system and method allows higher efficiencies to be obtained over prior art methods for mass transfer in gas-liquid systems that have a significant surfactant component, for similar power inputs. Similarly, the economic advantages of the present system and method of treating wastewater include: (i) allowing higher Oxygen Transfer Efficiencies (OTE) to be obtained in systems that have high surfactant content; and (ii) reduction in the total power required to deliver gases in surfactant laden streams.

From the foregoing, it should be appreciated that the present invention thus provides a system and method for treating surfactant laden wastewater. More specifically, the present system and method provides a means for enhancing mass transfer in surfactant laden systems. The improvements will apply particularly to wastewater treatment systems that have high a surfactant component, and generally, to all wastewater systems since the biochemical transformations that occur in wastewater processes have the potential for generating surfactants, such as extracellular polymeric substances (EPS) anss Soluble Microbial products (SMP), that might even possess greater surfactant activity than commercial surfactants.

Various embodiments of the present system and method may include: (i) sintered metal sparger, ceramic membrane or polymeric material with <100 micron pores is used to deliver gas at, above or below the impeller in a submerged mechanically agitated contacting system; (ii) sintered metal sparger, ceramic membrane or polymeric material with <100 micron pores is used to deliver gas below the liquid level but at, above or below the impeller, in a near surface mechanically agitated contacting system (iii) sintered metal sparger, ceramic membrane or polymeric material with <100 micron pores is incorporated into the venturi or injector nozzle used to deliver gas into a side stream pumping system on the discharge side; or (iv) sintered metal sparger, ceramic membrane or polymeric material with <100 micron pores is incorporated into the venturi or injector nozzle used to deliver gas into a side stream pumping system on the suction side.

While the invention herein disclosed has been described by means of specific embodiments and processes associated therewith, numerous modifications and variations can be made thereto by those skilled in the art without departing from the scope of the invention as set forth in the claims or sacrificing all of its features and advantages.

1. A wastewater treatment system for treating surfactant laden wastewater comprising:
an aeration basin;
a source of oxygen;
a mechanical agitating contactor disposed in the aeration basin, the mechanical agitating contactor comprising a draft tube having at least one inlet opening and at least one discharge opening and with an agitator or impeller disposed therein to create a flow of the surfactant laden wastewater by drawing the wastewater into the draft tube from the at least one inlet opening and discharging the liquid flow from the at least one discharge opening;
an oxygen injection system disposed below the surface of the surfactant laden wastewater and proximate to the mechanical agitating contactor and operatively coupled to the source of oxygen, the oxygen injection system adapted to produce oxygen bubbles proximate the impeller, the oxygen bubbles having an average diameter of less than or equal to 100 microns.

2. The wastewater treatment system of claim 1, wherein the mechanically agitating contactor further comprises a downward pumping impeller operatively coupled to a motor configured to rotate the impeller at a sufficient speed such that the surfactant laden wastewater drawn into the draft tube has a minimum superficial velocity greater than a terminal ascent velocity of the oxygen bubbles to enable the entrainment of the oxygen bubbles into the surfactant laden wastewater discharged from the draft tube.

3. The wastewater treatment system of claim 2, wherein the impeller is a helical impeller.

4. The wastewater treatment system of claim 1, wherein the oxygen injection system further comprises one or more spargers located inside the draft tube at radially spaced locations thereof and having a plurality of openings formed by a metallic, sintered metal or polymeric ultrafine bubble surface layers sized to produce the oxygen bubbles with the average diameter of less than or equal to 100 microns.

5. The wastewater treatment system of claim 4, wherein the one or more spargers further comprise one or more ring-like elements located inside the draft tube and having an inlet for the oxygen penetrating a sidewall of the draft tube.

6. The wastewater treatment system of claim 1, wherein the oxygen injection system further comprises a plurality of nozzles situated above or below or alongside the agitator or impeller and configured to produce the oxygen bubbles with the average diameter of less than or equal to 100 microns.

7. A wastewater treatment system for treating surfactant laden wastewater comprising:
a sidestream loop fluidically coupled to a basin in a wastewater treatment facility;
a mechanical agitating contactor disposed in the sidestream loop, the mechanical agitating contactor comprising an agitator or impeller configured to create a flow of the surfactant laden wastewater in the sidestream loop;
a source of oxygen;
an oxygen injection system disposed below the surface of the surfactant laden wastewater and proximate to the mechanical agitating contactor and operatively coupled to the source of oxygen, the oxygen injection system adapted to produce oxygen bubbles proximate the agitator or impeller, the oxygen bubbles having an average diameter of less than or equal to 100 microns.

8. A method of treating surfactant laden wastewater in a basin or vessel, the basin or vessel having a mechanical agitating contactor submerged therein, the mechanical agitating contactor comprising a draft tube having at least one inlet opening and at least one discharge opening and an agitator or impeller disposed within the draft tube, the method comprising the steps of:
rotating the agitator or impeller disposed within the draft tube to create a flow of the surfactant laden wastewater by drawing the wastewater into the draft tube from the at least one inlet opening and discharging the wastewater from the at least one discharge opening;
injecting oxygen bubbles into the surfactant laden wastewater within the draft tube at a location proximate the agitator or impeller;
wherein the surfactant laden wastewater drawn into the draft tube has a minimum superficial velocity greater than a terminal ascent velocity of the oxygen bubbles to enable the entrainment of the oxygen bubbles into the surfactant laden wastewater discharged from the draft tube; and
wherein the oxygen bubbles entrained in the surfactant laden wastewater discharged from the draft tube have an average diameter of less than or equal to 100 microns.

9. The method of claim 8, wherein the agitator or impeller is a downward pumping helical impeller.

10. The method of claim 8, wherein the step of injecting oxygen bubbles into the surfactant laden wastewater within the draft tube at a location proximate the agitator or impeller further comprises delivering pressurized gaseous oxygen from a source of oxygen to one or more spargers located inside the draft tube at radially spaced locations thereof, the one or more spargers having a plurality of openings formed by a metallic, sintered metal or polymeric ultrafine bubble surface layers configured to produce the oxygen bubbles and direct the oxygen bubbles at or near the agitator or impeller.

11. The method of claim 10, wherein the one or more spargers further comprise one or more ring-like elements located inside the draft tube and having an inlet for penetrating a sidewall of the draft tube configured to receive the pressurized gaseous oxygen.

12. The method of claim 8, wherein the step of injecting oxygen bubbles into the surfactant laden wastewater within the draft tube at a location proximate the agitator or impeller further comprises delivering pressurized gaseous oxygen from a source of oxygen to a plurality of nozzles situated above or below or alongside the agitator or impeller, the nozzles configured to produce the oxygen bubbles having an average bubble diameter of less than or equal to 100 microns and direct the oxygen bubbles at or near the agitator or impeller.
